(19) United States
(12) Patent Application Publication
(10) Pub. No.: US 2026/0256644 A1
(43) Pub. Date: Sep. 3, 2026

(54) MASSAGE DEVICE HAVING ADJUSTABLE MASSAGE DEPTH

(71) Applicant: SHENZHEN YUYI ELECTRONIC TECHNOLOGY CO., LTD., Shenzhen City, Guangdong Province (CN)

(72) Inventors: YING ZHOU, Shenzhen City, Guangdong Province (CN); BING LI, Shenzhen City, Guangdong Province (CN)

(21) Appl. No.: 19/163,379

(22) PCT Filed: Oct. 16, 2023
(86) PCT No.: PCT/CN2023/124673

§ 371 Date: Sep. 8, 2025

(30) Foreign Application Priority Data
Mar. 8, 2023 (CN) 202310250406.4

(51) Int. Cl. A61H 23/00; A61H 23/02

(52) U.S. Cl. CPC A61H 23/006; A61H 23/0254; A61H 2201/0192; A61H 2201/149; A61H 2201/1664

(57) ABSTRACT

A massage device having an adjustable massage depth. The massage device comprising a driving device, a crank, a connecting rod, and a massage head assembly, wherein one end of the connecting rod is connected to the crank, and the other end thereof is connected to the massage head assembly; the driving device rotate the crank, and the massage head assembly is driven by means of the connecting rod to perform a massage; and one end of the connecting rod is connected to the crank by means of a movable connecting assembly. The massage device further comprises an adjustment assembly to move the movable connecting assembly, and the movement of the movable connecting assembly enables the distance between the connecting position of the connecting rod and the crank and the rotation center axis to change, so as to adjust the massage depth of the massage head assembly.

### TECHNICAL FIELD

The present invention relates to the technical field of medical care equipment, in particular to a massage device with adjustable massage depth.

### BACKGROUND TECHNOLOGY

Massage devices are now commonly used to help people relax and maintain their health. For example, a fascia gun is a great tool for stretching and recovery after exercise. Muscle soreness is common in life, and both professional athletes and casual enthusiasts have experienced it. A fascia gun uses vibrations to massage large muscle groups, relaxing the fascia and reducing soreness. It can be used by both professional athletes and amateur bodybuilders, making training more effective. The vibration frequency of a fascia gun relieves muscle spasms, increases blood flow, and significantly shortens muscle recovery time.

The motor shaft of an existing fascia gun is connected to an eccentric wheel, which is rotatably connected to a connecting rod. The two ends of the connecting rod are connected to the motor shaft and a massage head. When the motor shaft rotates, the eccentric wheel and the connecting rod drive the massage head to move back and forth, providing high-frequency tapping on the human body. However, this commonly used fascia gun only has a single massage force and amplitude, and can only offer a single massage depth. Due to the difference in the thickness of the fascia layer in different parts of the human body, such as the head, hands, legs, buttocks, back, etc. the depth of the fascia layer varies in different positions. Therefore, the massage depth of the massage head also needs to be adjusted accordingly, which is not possible with traditional fascia massage guns.

Therefore, it is necessary to provide a massage device that can solve the problem that existing massage devices on the market, such as fascia guns, cannot adjust the movement depth of the massage head.

### SUMMARY OF THE INVENTION

### Technical Problem

The technical problem to be solved by the present invention is to provide a massage device with adjustable massage depth, so as to solve the problem that existing massage devices cannot adjust the movement depth of the massage head.

### Technical Solutions

To obtain the object of the present application, the following technical solutions are provided:

a massage device with adjustable massage depth, comprising a driving device, a crank, a linkage rod, and a massage head assembly; one end of the linkage rod is connected to the crank, and the other end is connected to the massage head assembly; the driving device is used to drive the crank to rotate about a rotation center axis L1, and drive the massage head assembly to perform massage actions through the linkage rod; one end of the linkage rod is connected to the crank through a movable connection assembly; the massage device further comprises an adjustment assembly; the adjustment assembly drives the movable connection assembly to move, and the movement of the movable connection assembly changes a distance between a connection position of the linkage rod to the crank and the rotation center axis L1, thereby adjusting the massage depth of the massage head assembly.

In some embodiments, the movable connection assembly comprises a nut member and a bolt member that are threadedly engaged with each other; the bolt member comprises an external threaded shaft and a head, and the nut member is sleeved on the external threaded shaft; when the bolt member rotates forward and reverse, the nut member reciprocates linearly along the external threaded shaft; the nut member is connected to one end of the linkage rod and is mounted to the crank; the adjustment assembly drives the bolt member to rotate forward and reverse.

In some embodiments, the head of the bolt member is a toothed head, and the adjustment assembly comprises a toothed structure that meshes with the toothed head of the bolt member to drive the head of the bolt member to rotate forward and reverse; or, the head is a nut head, and the adjustment assembly comprises a tangential force mechanism that provides tangential force to the nut head to drive the head of the bolt member to rotate forward and reverse.

In some embodiments, the toothed structure of the adjustment assembly is a rack or a gear, and correspondingly, the toothed head of the bolt member is provided with straight teeth or helical teeth; the tangential force mechanism of the adjustment assembly is a pull rod which is connected to the nut head to provide a tangential pulling force.

In some embodiments, the bolt member is a bevel gear, and the toothed head is a bevel-gear head; the toothed structure of the adjustment assembly is a rack or a bevel gear; and the bevel gear either of the bolt member or the adjustment assembly comprises a bevel-gear head and an external threaded shaft.

In some embodiments, the nut member is pivotally connected to one end of the linkage rod at a central axis L2, which is parallel to the rotation center axis L1; a central axis of the bolt member is arranged along a crank rotation radius R and is perpendicular to the rotation center axis L1.

In some embodiments, the adjustment assembly comprises a threaded assembly or a gear assembly, and further comprises a transmission assembly; the transmission assembly is connected between the movable connection assembly and the threaded assembly or the gear assembly, and the movement of the threaded assembly or the gear assembly drives the movable connection assembly to move through the transmission assembly; the transmission assembly comprises a movable block and a transmission member; the movable block is connected to the threaded assembly or the gear assembly, the movement of the threaded assembly or the gear assembly drives a movement of the movable block; the movement of the movable block drives a movement of the transmission member, which in turn drives the movement of the movable connection assembly; the threaded assembly or the gear assembly is moved by a manual manner or an electric driving device.

In some embodiments, the adjustment assembly comprises a threaded assembly and a transmission assembly; the transmission assembly comprises a movable block and a transmission member; the movable block is connected to the threaded assembly, and a movement of the threaded assembly drives the movable block to move; the movable block cooperates with the transmission member, and the movable block drives the transmission member to move; or, the transmission member and the movable block are an integral component, and the movable block and the transmission member are movable together; the movement of the transmission member drives the movable connection assembly to move; the driving device comprises an output shaft, which is connected to the crank to drive the crank to rotate forward and reverse about the rotation center axis L1, and the output shaft is located on the rotation center axis L1.

In some embodiments, the threaded assembly comprises an adjustment disk and a threaded sleeve threadedly that is engaged with the adjustment disk; the adjustment disk has a central shaft hole, which is internally threaded; the threaded sleeve is externally threaded, one end of the threaded sleeve is sleeved in the central shaft hole of the adjustment disk and is threadedly engaged, and the other end is connected to the movable block; when the adjustment disk rotates forward and reverse, the threaded sleeve performs a linear reciprocating motion in the central shaft hole of the adjustment disk; the linear reciprocating motion of the threaded sleeve drives a linear reciprocating motion of the movable block; the adjustment disk is driven to rotate forward and reverse by a manual manner or an electric driving device.

In some embodiments, the movable block has a shaft hole, and the crank has a central shaft hole; the other end of the threaded sleeve is connected to the shaft hole of the movable block; a shaft sleeve is coaxially arranged outside the output shaft to protect the output shaft, and the output shaft is rotatable forward and reverse within the shaft sleeve; the output shaft and the shaft sleeve are inserted into the central hole of the adjustment disk and the threaded sleeve in the central shaft hole of the adjustment disk, and further inserted into the shaft hole of the movable block, and the end of the output shaft is connected to the central shaft hole of the crank to drive the crank to rotate forward and reverse together.

In some embodiments, a limit guide structure is provided between the threaded sleeve and the shaft sleeve to enable the threaded sleeve to reciprocate linearly along the shaft sleeve; a limit guide structure is provided between the movable block and the crank to guide and limit the movable block to perform the linear reciprocating motion relative to the crank while rotate together with the crank; a matching structure of an annular flange and annular groove is provided between the other end of the threaded sleeve and the shaft hole of the movable block, and the other end of the threaded sleeve is connected to the movable block by means of the flange being received in the annular groove; a connection between the movable block and the threaded sleeve is configured such that the movable block is rotatable forward and reverse relative to the threaded sleeve while is reciprocatable linearly together with the threaded sleeve.

In some embodiments, the transmission member is a toothed structure, and the movable connection assembly comprises a nut member and a bolt member that are threadedly engaged with each other; the bolt member comprises an external threaded shaft and a head; the head of the bolt member is a toothed head, which meshes with the toothed structure of the transmission member, thereby, the movement of the transmission member drives the bolt member to rotate forward and reverse; or, the transmission member is a tangential force mechanism that provides tangential force to the head of the bolt member to drive the bolt member to rotate forward and reverse through the movement of the transmission member In some embodiments, the transmission member is a bevel gear or a spur gear, comprising an external threaded shaft and a bevel-gear head or a straight-tooth head; the movable block has an internal threaded hole, and the external threaded shaft of the transmission member is inserted into the internal threaded hole and threadedly engaged therewith; the linear reciprocating motion of the movable block drives the transmission member to rotate forward and reverse; the toothed head of the bolt member is a bevel-gear head or a straight-tooth head; the two bevel-gear heads or two straight-tooth heads of the transmission member and the bolt member engage with each other, and a forward and reverse rotation of the transmission member drives the bolt member to rotate forward and reverse; or, the transmission member is a rack, which is mounted to the movable block or is an integral part of the movable block, and reciprocates together with the movable block; the rack engages with the toothed head of the bolt member, and a linear reciprocating motion of the rack drives the bolt member to rotate forward and reverse; or, the transmission member is a pull rod, which is mounted to the movable block or is an integral part of the movable block, and reciprocates together with the movable block; an end of the pull rod is connected to the head of the bolt member, and a linear reciprocating motion of the pull rod provides tangential pulling force to the head of the bolt member, thereby driving the bolt member to rotate forward and reverse.

In some embodiments, the massage device comprises a housing, a power supply assembly, and a control board assembly; the driving device, the crank, the linkage rod, the massage head assembly, the power supply assembly, and the control board assembly are arranged in the housing; the control board assembly comprises a main control board and buttons; the buttons, the power supply assembly, and the driving device are electrically connected to the main control board; the main control board is provided with a charging port for connecting an external power supply.

### ADVANTAGE EFFECTS

Advantages of the present invention are as follows:

the massage device with adjustable massage depth of the present invention is provided with an adjustment disk and a threaded transmission, so that the linkage rod connected to the massage head can be adjusted closer to or farther away from the rotation central axis of the eccentric wheel to adjust the eccentric distance, thereby achieving the movement depth of the massage head or adjustable massage depth.

### BRIEF DESCRIPTION OF DRAWINGS

FIG. 1 is a perspective view of a massage device with adjustable massage depth according to an embodiment of the present invention;

FIGS. 2-3 are perspective views of part structures of the massage device with adjustable massage depth according to the embodiment of the present invention;

FIG. 4 is a cross-sectional view of part structures of the massage device with adjustable massage depth according to the embodiment of the present invention;

FIG. 5 is an exploded view of the massage device with adjustable massage depth according to the embodiment of the present invention;

FIG. 6 is a perspective view of a driving device according to the embodiment of the present invention;

FIG. 7 is a perspective view of a crank according to the embodiment of the present invention;

FIG. 8 is a schematic diagram of an adjustment assembly and the crank-connecting rod assembly according to the embodiment of the present invention;

FIG. 9 is an exploded view of the massage device with adjustable massage depth according to a second embodiment of the present invention;

FIG. 10 is a cross-sectional view of part structures of the massage device with adjustable massage depth according to the second embodiment of the present invention;

FIG. 11 is a cross-sectional view of parts of the massage device with adjustable massage depth according to the second embodiment of the present invention; and

FIG. 12 is a cross-sectional view of parts of the massage device with adjustable massage depth according to the second embodiment of the present invention.

### DETAILED DESCRIPTION OF THE INVENTION

The exemplary embodiments of the present invention will be described in more detail below with reference to the accompanying drawings. Although shown exemplary embodiments of the present invention in the accompanying drawings, yet it should be understood that the present invention can be implemented in various forms and should not be limited by the embodiments set forth herein. On the contrary, these embodiments are provided to enable a more thorough understanding of the present invention and to fully convey the scope of the present invention to those skilled in the art.

It should be understood that the terms used herein are only for the purpose of describing specific exemplary embodiments and are not intended to be limiting. Unless the context clearly indicates otherwise, the singular forms “a”, “an” and “the” as used in the text may also be construed to include plural forms. The terms “comprising”, “including”, “containing” and “having” are inclusive and thus indicate the existence of the stated features, steps, operations, elements and/or components, but do not exclude the existence or addition of one or more other features, steps, operations, elements, components and/or combinations thereof. The method steps, processes and operations described herein are not to be construed as requiring them to be performed in the specific order described or illustrated, unless an order of performance is expressly indicated. It should also be understood that additional or alternative steps may be used.

Although terms such as “first”, “second”, etc., can be used to describe multiple elements, components, regions, layers and/or sections in the text, these elements, components, regions, layers and/or sections should not be limited by these terms. These terms may only be used to distinguish one element, component, region, layer or section from another element, component, region, layer or section. Unless the context clearly indicates otherwise, terms such as “first”, “second” and other numerical terms do not imply sequence or order when used in the text.

Therefore, the element, component, region, layer or section discussed below may be referred to as the second element, component, region, layer or section without departing from the teaching of the exemplary embodiments.

For ease of description, spatial relative terms such as “inside”, “outside”, “inner”, “outer”, “below”, “lower”, “above”, “upper”, “front end”, “rear side” and the like may be used herein to describe the relationship between one element or feature and another element or feature as shown in the figures. Such spatial relative terms are intended to include different orientations of the device in use or operation in addition to the orientation depicted in the figures. For example, if the device in the figure is turned over, elements described as “below other elements or features” or “under other elements or features” would then be oriented as “above other elements or features” or “over other elements or features”. Therefore, the exemplary term “below” can include both upper and lower orientations. The device may be otherwise oriented (rotated by 90 degrees or in other orientations) and the spatial relative descriptors used herein be interpreted accordingly.

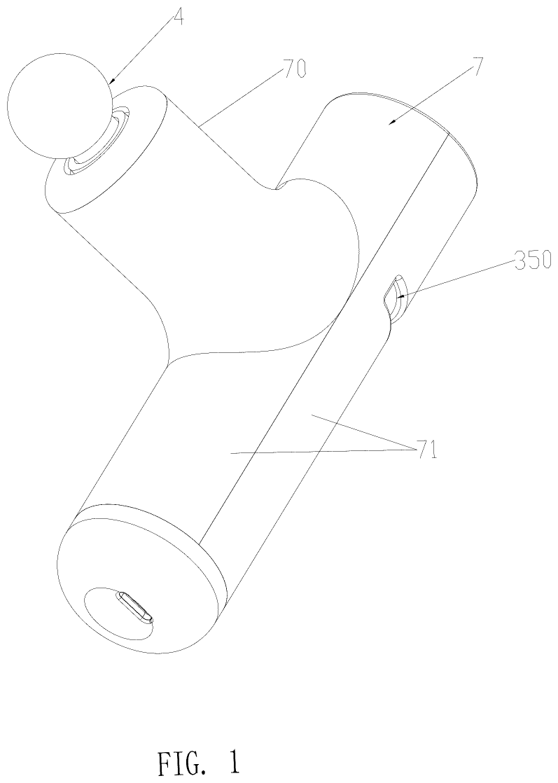

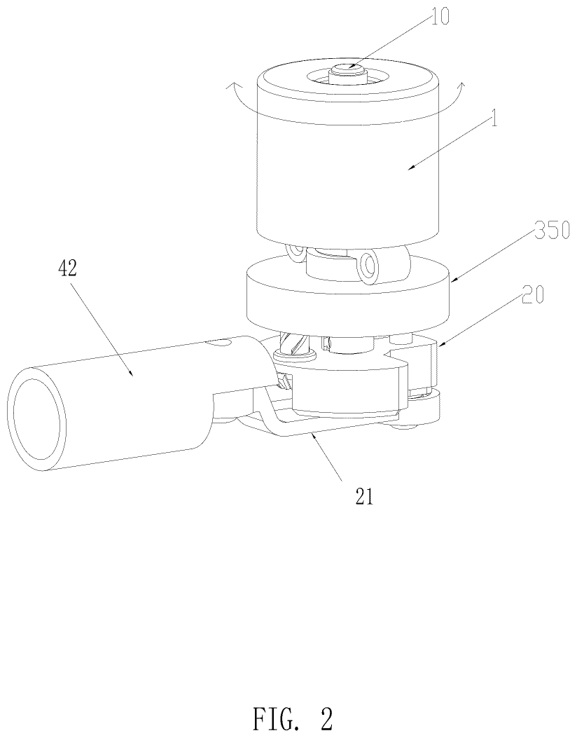

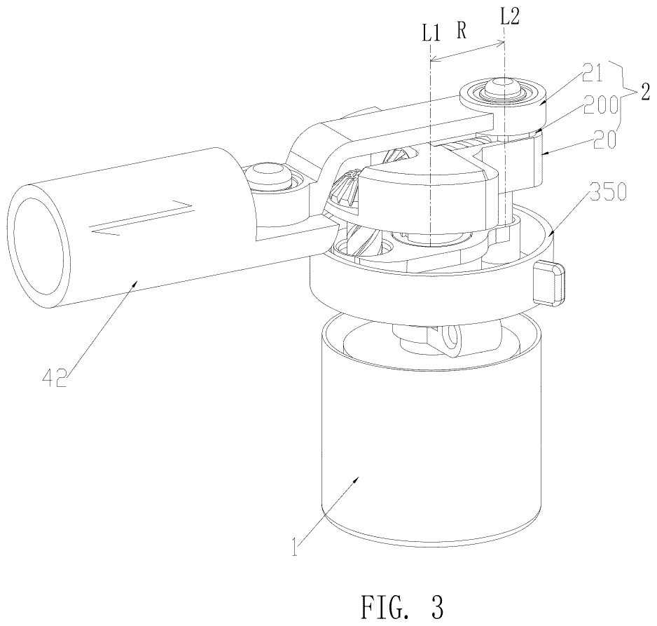

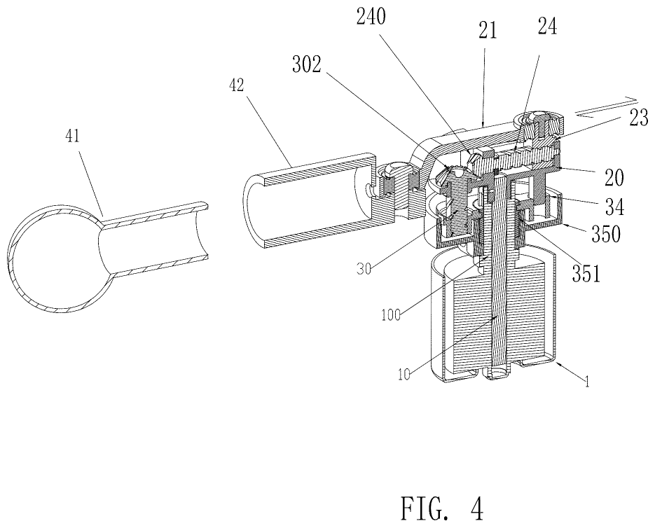

Referring to FIGS. 1-12, the present invention relates to a massage device with adjustable massage depth, which comprises a housing 7 and a driving device 1, a crank-linkage rod assembly 2, an adjustment assembly 3, a massage head assembly 4, a power supply assembly and a control board assembly installed in the housing 7. The crank-linkage rod assembly 2 comprises a crank 20 and a linkage rod 21. The driving device 1 is connected to the crank 20 to drive the crank 20 to rotate about a rotation center axis L1. For example, the crank 20 defines a shaft hole 22, and the driving device 1 comprises an output shaft 10 that can rotate forward and reverse; the output shaft 10 is connected to the shaft hole 22 to drive the crank 20 to rotate together; the output shaft 10 and the shaft hole 22 are coaxial with the rotation center axis L1. The two ends of the linkage rod 21 are respectively connected to the massage head assembly 4 and the crank 20; the crank rotates to drive the linkage rod 21 to reciprocate, thereby driving the massage head assembly 4 to perform massage actions. A connection position of the linkage rod 21 on the crank 20 can be movably adjustable. A central axis of the position of the linkage rod 21 connected to the crank 20 is L2. The central axis L2/the position of the linkage rod 21 connected to the crank 20 are adjustable relative to the crank 20/the output shaft 10 of the driving device/the rotation center axis L1. A distance between the position of the linkage rod 21 connected to the crank 20/the central axis L2 and the output shaft 10 of the driving device/the shaft hole 22 of the crank/the rotation center axis L1, corresponds to a crank rotation radius R, which is movably adjustable so that the connection position (the central axis L2) of the linkage rod 21 on the crank 20 is closer to or farther away from the output shaft 10 of the driving device/the shaft hole 22 of the crank, i.e., the rotation radius R decreases or increases, thereby adjusting a massage depth (an amplitude) of the massage head assembly 4. The massage head assembly 4 comprises a connection assembly 40 and a massage head 41; the connection assembly 40 is connected to the massage head 41 and the linkage rod 21; a reciprocating motion of the linkage rod 21 drives the massage head 41 to perform a piston-like reciprocating motion through the connection assembly 40, thereby achieving the function of repeated tapping massage. The control board assembly comprises a main control board 6. The power supply assembly and the driving device 1 are electrically connected to the main control board to provide power to the driving device 1 and control the operation of the massage device. The adjustment assembly 3 is used to adjust the connection position (central axis L2) of the linkage rod 21 on the crank 20, thereby adjusting the crank rotation radius R, thereby adjusting the amplitude of the massage head 41, achieving different tapping depths for different fascia layers. The housing 7 comprises a front housing 70, a rear housing 71, and two end housings 73 and 74, which together form an internal cavity. The front housing 71 forms a sleeve; the connection assembly 40 of the massage head assembly 4 is installed in the sleeve of the front housing, driving the massage head 41 to reciprocate along the shell sleeve.

The central axis L2 of the position of the linkage rod 21 connected to the crank 20 is parallel to the output shaft 10 of the driving device or the rotation center axis L1. For ease of description, the direction of the axes L1, L2 or the direction parallel to them is defined as an axial direction, up-down direction or vertical direction; the orthogonal direction thereof is defined as the horizontal direction, left-right direction or radial direction. The distance between the connection position (central axis L2) of the linkage rod 21 on the crank 20 and the output shaft 10 of the driving device/the shaft hole 22 of the crank/the rotation center axis LI corresponds to the crank rotation radius R.

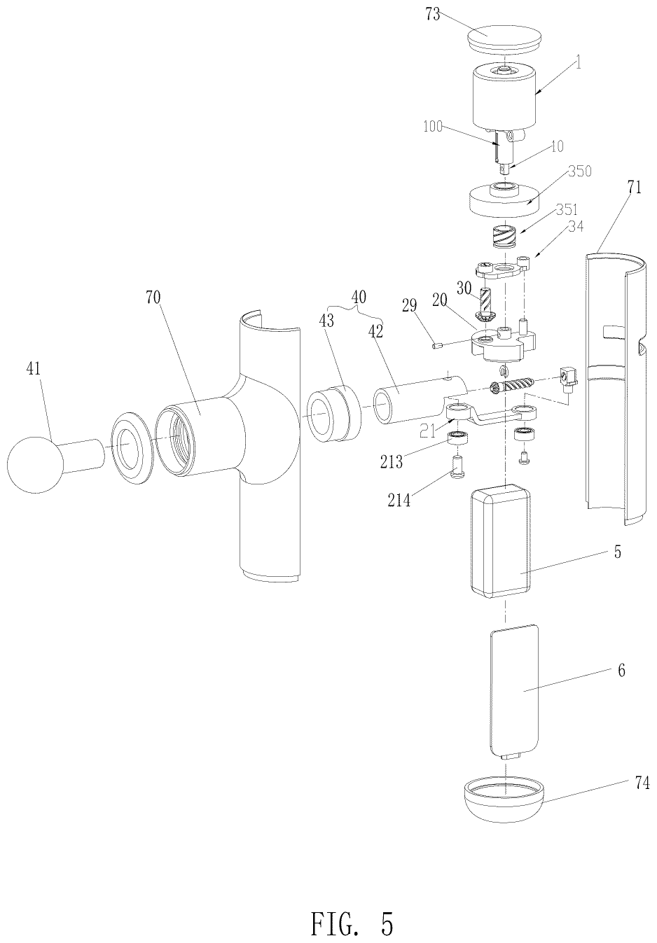

Referring to FIG. 6, in this embodiment, the driving device 1 comprises an output shaft 10 that can rotate forward and reverse. A shaft sleeve 100 is provided on the outside of the output shaft. The shaft sleeve 100 may be a fixed structure provided on a mounting bracket of the driving device, coaxially arranged with the output shaft 10, and sleeved on the outside of the output shaft 10 to protect the output shaft 10. The output shaft 10 is rotatable in the shaft sleeve. For example, an axial limit guide structure 13 is provided on the outer wall of the shaft sleeve 100. For example, the limit guide structure 13 may be a linear sliding groove or a linear raised rail (rib) or other structures, which are used to limit and guide the axial (up and down) movement of the adjustment assembly 3. The output shaft 10 is connected to the crank to drive the crank to rotate synchronously. The output shaft 10 is also provided with an exemplary fixing connection structure such as a hole 11 provided at an end 12 of the output shaft 10, and the end 12 is preferably non-cylindrical so as to be tightly fitted in the shaft hole of the crank 20 to achieve synchronous rotation. In this embodiment, the driving device 1 is a motor; other conventional electric driving device can also be used to drive the crank 20 in forward and reverse rotation.

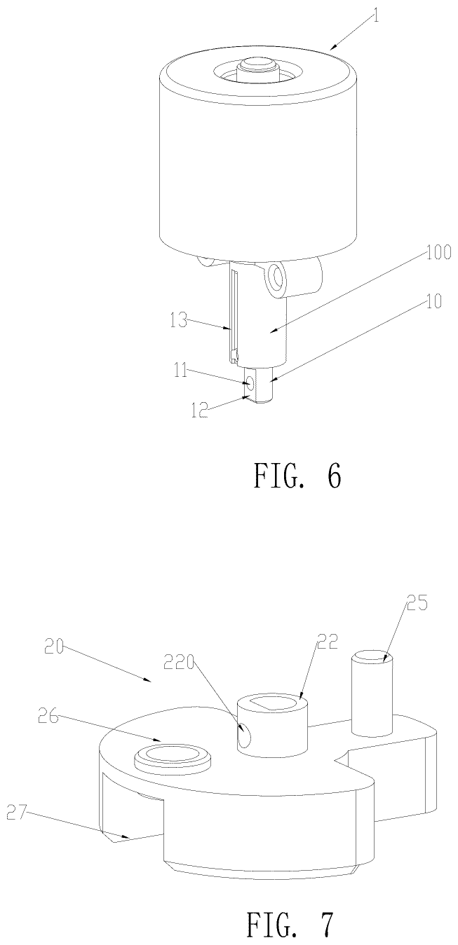

Referring to FIG. 7, for example, the crank 20 is provided with a shaft hole 22; the shaft hole 22 is preferably a non-circular hole; the output shaft 10 of the driving device is inserted into the central shaft hole 22 and will not rotate relative to each other; the output shaft 10 of the driving device and the shaft hole 22 form a pivot connection; the end 12 of the output shaft 10 is inserted into the shaft hole 22 of the crank 20 for interference fit or fixed connection. For example, the side wall of the shaft hole 22 is provided with a mounting hole 220; the mounting hole 220 corresponds to the hole 11 at the end of the output shaft; when the output shaft 10 is inserted into the shaft hole 22, the holes 11 and 220 are aligned and locked by a fastener such as a pin 29, thereby fixing the end of the output shaft 10 of the driving device to the crank 20. Of course, the output shaft 10 of the driving device and the crank 20 may also be non-fixedly connected, as long as the output shaft 10 of the driving device can drive the crank 20 to rotate. The crank 20 is provided with a matching structure for installing the adjustment assembly 3; for example, the matching structure includes a limit guide structure such as a guide column (or guide hole) 25 and a through-hole 26.

The linkage rod 21 has shaft holes (or mounting holes) 210 and 211 formed at both ends thereof, which are used to connect to the crank 20 and the massage head assembly 4, respectively.

The present invention is provided with a movable connection assembly 200 that movably and adjustably connects one end of the linkage rod 21 to the crank 20; the connection position of the end of the linkage rod 21 to the crank 20 can be adjusted to move closer to or farther from the crank rotation center axis L1. The movable connection assembly 200 enables the connection position to move along the crank rotation radius, i.e., linearly move in a direction perpendicular to the crank rotation center axis L1. In this embodiment, the movable connection assembly 200 is, but is not limited to, a bolt assembly (also indicated by the reference numeral “200”), which comprises a nut member 23 and a bolt member 24. The bolt member 24 comprises an external threaded shaft 241 and a head 240 thereof; the head 240 may be configured as a circular nut, a gear or other structures that can be easily driven to rotate. The nut member 23 has an internal threaded hole 230, which is threadably sleeved on the external threaded shaft 241, and can reciprocate linearly along the external threaded shaft 241 (the axis of the bolt member).

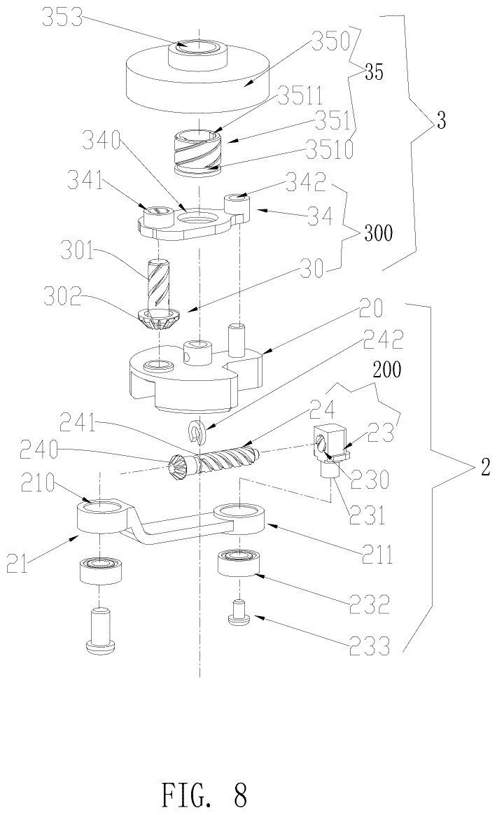

Referring to FIG. 8, the bolt member 24 is mounted on the crank 20; the internal threaded hole 230 of the nut member 23 is sleeved outside the external threaded shaft 241 of the bolt member 24 with threaded engagement. The nut member 23 is connected to one end of the linkage rod 21; for example, the nut member 23 is pivotally connected to one end of the linkage rod; the nut member 23 is provided with a short pivot (extending column) 231 with a mounting hole therein. The short pivot (extending column) 231 of the nut member 23 is inserted into the shaft hole 211 at one end of the linkage rod 21 to form a pivot connection. A washer (or bearing) 232 may be sleeved in the shaft hole 211 first, and the short pivot 231 is inserted into the washer (or bearing) 232, thereby connecting the short pivot 231 of the nut member 23 to the shaft hole 211 of the linkage rod. The pivotal connection between the nut member 23 and the linkage rod 21 may be a rotatable connection or a fixed connection (such as interference fit); and the pin and the hole of the pivotal connection may be interchangeable. A fastener such as (but not limited to) a screw (or screw-like structure) 233 is inserted into the mounting hole in the end of the short pivot 231, and the screw cap is fastened to the washer 232 and the shaft hole 211, thereby limiting the connection of the short pivot of the nut member 23 in the shaft hole of the linkage rod 21 to prevent falling off. The nut member 23 is pivotally connected to the linkage rod 21 at the central axis L2. The forward and reverse rotation (self-rotation) of the bolt member 24 can drive the nut member 23 to reciprocate linearly, moving the nut member along the external threaded shaft 241 to different positions, thereby adjusting the position of the linkage rod 21 connected to the crank 20. The central axis of the bolt member 24 is oriented along the crank rotation radius R and is orthogonal to the output shaft 10 of the driving device. Therefore, the nut member 23 drives the linkage rod 21 to be movably connected to the crank 20, allowing the position of the connection position (central axis L2) of the linkage rod 21 on the crank 20 to be adjustable, thereby adjusting the crank rotation radius R 20 to adjust the massage depth.

For example, the crank 20 is provided with a mounting cavity 27; the bolt member 24 is rotatably (self-rotatably) installed in the mounting cavity 27. An annular retaining groove is provided on the threaded shaft 241 of the bolt member 24. A retaining ring 242 is retained within the annular retaining groove of the threaded shaft 241 to limit the position of the bolt member 24. Alternatively, a support wall with an axial hole is provided on the crank 20 (in the mounting cavity or on an end wall), and the threaded shaft 241 is rotatably inserted into the axial hole, with the support wall supporting the bolt member 24. In a non-limiting manner, the head 240 of the bolt member 24 at least partially protrudes from the outside of the crank 20. The connection position of one end of the linkage rod 21 to the crank 20 is movably adjusted through the bolt assembly 200 (wherein the nut member 23 is threadedly engaged with the bolt member 24 to reciprocate linearly).

The adjustment assembly 3 is used to move the movable connection assembly (bolt assembly) 200, thereby adjusting the connection position closer to or farther from the crank rotation center axis L1, and the position of the linkage rod connected to the crank is adjustable and movable along the crank rotation radius R. The adjustment assembly 3 may be, but not limited to, a threaded assembly or a gear assembly; for example, a threaded assembly 35 is adopted. The threaded assembly 35 comprises an adjustment disk 350 and a threaded sleeve 351 that are threadedly engaged with each other; and the adjustment disk 350 rotates forward and reverse to cause the threaded sleeve 351 to reciprocate axially. The adjustment disk 350 may be designed as (but not limited to) a circular knob shape, and its surface may be configured to increase friction, for example, by providing a rough surface, protrusions or teeth. The adjustment disk 350 is provided with a central shaft hole 353, which is internally threaded. The threaded sleeve 351 is externally threaded; one end of the threaded sleeve 351 is inserted into the central shaft hole 353 of the adjustment disk 350 and threadedly engages therewith, and the other end is connected to a movable block 34 described below. Rotation of the adjustment disk 350 can drive the threaded sleeve 351 to axially move up and down along. An annular groove 3510 is formed at the other end of the threaded sleeve 351. A limit guide structure 3511, such as a raised rail (rib) or a linear sliding groove, is formed on the inner wall of the threaded sleeve 351. The output shaft and the shaft sleeve thereon are inserted into the central shaft hole 353 of the adjustment disk; and the adjustment disk 350 and the threaded sleeve 351 inside the disk are sleeved on the outside of the output shaft 10 of the driving device and the shaft sleeve 100 thereon. The limit guide structure (sliding groove) 13 on the shaft sleeve 100 forms a relative linear sliding fit with the limit guide structure (raised rib) 3511 on the threaded sleeve 351 to guide the linear reciprocating (axially up and down) movement of the threaded sleeve 351, and enables the threaded sleeve 351 to move only up and down along the shaft sleeve 100 on the output shaft 10.

The adjustment assembly 3 further comprises a transmission assembly 300 connected between the threaded assembly 35 and the movable connection assembly (bolt assembly) 200. The threaded assembly 35 drives the movable connection assembly (bolt assembly) 200 to move via the transmission assembly 300. The transmission assembly 300 comprises the movable block 34 which is connected to the threaded sleeve 351. The threaded sleeve 351 drives the movable block 34 to reciprocate linearly synchronously. The transmission assembly 300 further comprises a transmission member 30 connected to or disposed on the movable block 34. The movable block 34 drives the transmission member 30 to reciprocate linearly synchronously, or cooperates with the transmission member 30 to rotate the transmission member 30 forward and reverse.

The movable block 34 is provided with the central shaft hole 340. For example, an annular flange is formed in the central shaft hole 340 of the movable block 34; the other end of the threaded sleeve 351 is sleeved in the central shaft hole 340; and the flange in the central shaft hole 340 engages in the annular groove 3510 on the threaded sleeve 35, forming a relative rotatable connection that does not disengage. When the movable block 34 rotates as a whole, the threaded sleeve 351 will not be driven to rotate. When the threaded sleeve 351 reciprocates linearly, it drives the movable block 34 to reciprocate linearly synchronously. The movable block 34 is provided with a limit guide structure, such as a guide hole (or guide column) 342.

The output shaft 10 of the driving device and its outer shaft sleeve 100 pass through the central shaft hole 340 of the movable block 34, the distal end 12 of the output shaft 10 is connected to the shaft hole 22 of the crank. The limit guide structure (guide column) 342 of the movable block 34 cooperates with the limit guide structure (guide hole) 25 on the crank 20 to guide and limit the axial reciprocating movement of the movable block 34 relative to the crank.

The transmission member 30 cooperates with the movable connection assembly (bolt assembly) 200 to drive the movable connection assembly (bolt assembly) 200 to move. For example, the transmission member 30 cooperates with the head 240 of the bolt member 24 to drive the head 240 to rotate, thereby driving the bolt member 24 to rotate. The transmission member 30 may be engage with the head 240 of the bolt member 24 in a gear or rack meshing manner or providing a tangential force to rotate the bolt member 24.

The connection assembly 40 of the massage head assembly 4 comprises a connecting sleeve 42 and a shock-absorbing sleeve 43. The shock-absorbing sleeve 43 is sleeved in the sleeve of the front housing, with interference fit or clamping fit. One end of the connecting sleeve 42 (provided with an axial bore) is pivotally connected to the shaft hole 210 at one end of the linkage rod via a pin 214 and a washer 213; the massage head 41 is fixedly connected to the connecting sleeve 42; and the connecting sleeve 42 drives the massage head 41 in reciprocating motion in the sleeve of the front housing. Different connection positions of the linkage rod 21 on the crank 20 result in different linear distances of the reciprocating motion of the connecting sleeve connected to the linkage rod and the massage head, so as to achieve different tapping depths for different fascia layers.

The power supply assembly may be a battery or a charging module. The control board assembly comprises a main control board 6 and buttons. The main control board is provided with a charging port, which is used to connect an external power source to charge the battery. When the massage device is activated through by pressing the buttons, the driving device (electric motor) operates, the output shaft 10 rotates, and the output shaft 10 drives the crank 20 to rotate. At this time, the assemblies 200 and 300 rotate synchronously with the crank; the rotation of the crank drives the massage head 41 through the linkage rod 21 and the connecting sleeve 42 to perform linear reciprocating motion for massage. During or before the massage operation of the massage device, the distance of linear motion of the massage head is adjustable by manually or electrically rotating the adjustment disk 350, thereby achieving different tapping depths for different fascia layers. The adjusting disk 350 can be manually operated, in which case the adjusting disk 350 is at least partially exposed outside the housing 7 for easy manual operation. Alternatively, the adjustment disk 350 may also be electrically driven, for example, by providing an additional electric motor and directly mounting the adjustment disk 350 on the output shaft of the electric motor, or by using the motor output shaft in conjunction with a gear transmission to rotate the adjustment disk 350.

Referring to FIG. 8, in a first embodiment of the present invention, the bolt member 24 adopts a bevel gear, including an external threaded shaft 241 and a bevel gear head 240 thereof; the nut member 23 has an internal threaded hole 230, which is sleeved on the threaded shaft 241 and threadedly engaged with each other, and can reciprocate linearly along the external threaded shaft 241 (the axis of the bolt member). The bolt member 24 is mounted to the crank 20; and a position of the nut member 23 (pivotally) connected to the crank 20 is movable and adjustable. The forward and reverse rotation (self-rotation) of the bevel gear of the movable connection assembly (bolt assembly) 200 enables the nut member 23 to reciprocate linearly, adjusting the position of the linkage rod 21 connected to the crank 20. The central axis of the bevel gear is arranged along the direction of the crank rotation radius R and is orthogonal to the output shaft 10 of the driving device. Correspondingly, the transmission member 30 and the bevel gear head 240 of the bevel gear are in gear engagement transmission; where the transmission member 30 also adopts a bevel gear, which comprises an external threaded shaft 301 and a bevel gear head 302. The movable block 34 is provided with an internal threaded hole 341; the external threaded shaft 301 is inserted into the internal threaded hole 34 with threaded engagement, and the linear reciprocating motion of the movable block 34 enables the transmission member (bevel gear) 30 to rotate forward and reverse. The transmission member (bevel gear) 30 and the bevel gear 24 are arranged with their axes orthogonal. The external threaded shaft 301 of the transmission member (bevel gear) 30 rotatably passes through the through-hole 26 in the crank 20. The bevel gear heads 240 and 302 of the bolt members (bevel gears) 24 and 30 form gear engagement transmission; the forward and reverse rotation of the transmission member (bevel gear) 30 drives the bolt member (bevel gear) 24 to rotate forward and reverse.

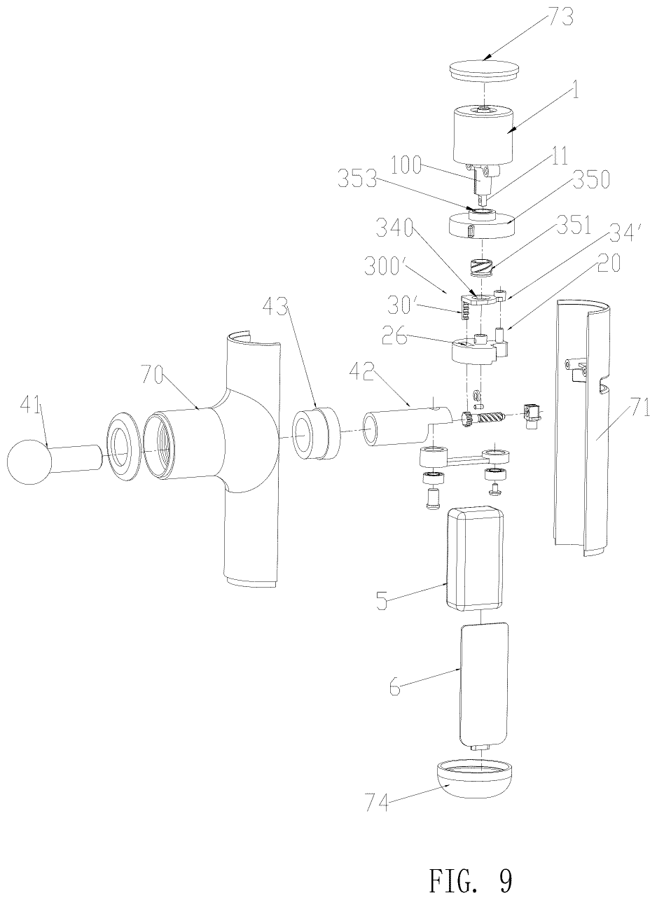

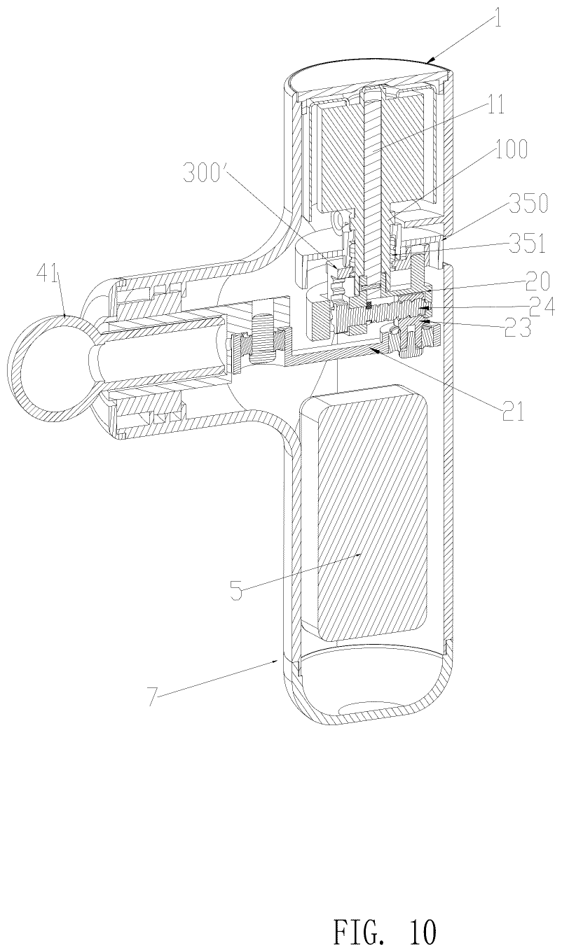

In this embodiment, the output shaft of the driving device and the shaft sleeve sequentially pass through the adjustment disk 350, the threaded sleeve 351, and the central shaft hole of the movable block 34. The end 12 of the output shaft is fixedly connected to the central shaft hole 22 of the crank 20. The threaded sleeve 351 is sleeved in the central shaft holes of the adjustment disk 350 and the movable block 34, and is threadedly engaged with the inner wall of the central shaft hole 353 of the adjustment disk 350. The threaded sleeve 351 moving linearly and axially along the inner wall of the adjustment disk 350, and drives the movable block 34 to reciprocate synchronously. The threaded engagement between the internal threaded hole 341 and the external threaded shaft 301 of the transmission member (bevel gear) 30 causes the transmission member (bevel gear) 30 to rotate; and the transmission member (bevel gear) 30 meshes with the bolt member (bevel gear) 24, causing the bolt member (bevel gear) 24 to rotate, which causes the nut member 23 and one end of the connected linkage rod connected thereto (the position connected to the crank) reciprocate linearly along the external threaded shaft 241 of the bolt member (bevel gear) 24, and the distance of the linear reciprocating motion of the massage head 41 connected to the other end of the linkage rod through the connecting sleeve 42 is adjusted accordingly to obtain different massage depths. Referring to FIGS. 9-10, which show the second embodiment of the massage device of the present invention, the difference from the first embodiment is that the transmission assembly 300 of the adjustment assembly 3 adopts a rack assembly 300′ instead. The rack assembly 300′ comprises a rack 30′ and a movable block 34′. The rack 30′ is arranged vertically to replace the transmission member (bevel gear) 30 in the first embodiment. The difference between the movable block 34′ and the movable block 34 in the first embodiment is that no internal threaded hole 341 is provided. The movable block 34′ of the second embodiment is similar to that of the first embodiment in that: the movable block 34′ is an annular disk provided with a central hole 340 and a limit guide structure (guide column) 342, and is arranged horizontally. The threaded sleeve 351 is sleeved in the central shaft holes 351 and 340 of the adjustment disk 350 and the movable block 34′, and the linear reciprocating motion of the threaded sleeve 351 drives the movable block 34′ to reciprocate synchronously. The rack 30′ corresponds to the internal threaded hole 341 of the movable block 34 and the transmission member 30 in the first embodiment. The rack 30′ and the movable block 34′ may be an integral component, the rack 30′ is arranged perpendicular to the movable block 34′; alternatively, the rack 30′ is fixedly and perpendicularly installed on the movable block 34′. The linear reciprocating motion of the threaded sleeve 351 drives the movable block 34′ to reciprocate synchronously, thereby synchronously driving the rack 30′ to reciprocate linearly up and down. The rack 30′ meshes with the bevel gear head 240 of the bolt member (bevel gear) 24; and the linear reciprocating motion of the rack 30′ makes the bolt member (bevel gear) 24 rotate forward and reverse. The rack 30′ passes through the through-hole 26 in the crank 20, with its end engaging with the bevel gear head 240 of the bolt member (bevel gear) 24. In the first embodiment, the through-hole 26 in the crank 20 is set as a circular hole to facilitate the external threaded shaft 301 of the transmission member (bevel gear) 30 to pass through the through-hole 26 and rotate freely; in the second embodiment, the through-hole 26 may be set as a square shape, which is adapted to the shape of the rack 30′ to enable the rack to move up and down freely.

Other structures of the massage device in the second embodiment are the same as those in the first embodiment, and the relevant descriptions in the first embodiment are directly introduced into the second embodiment and will not be repeated here.

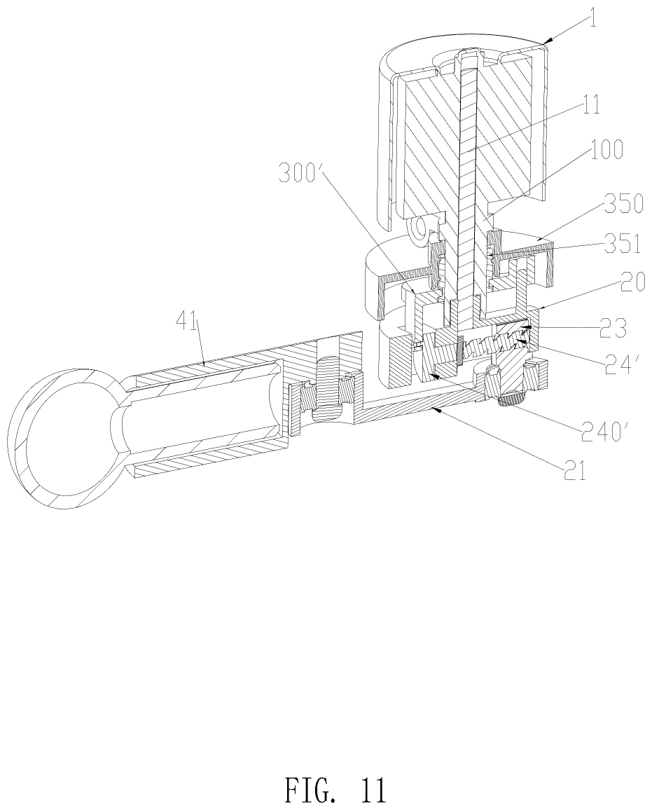

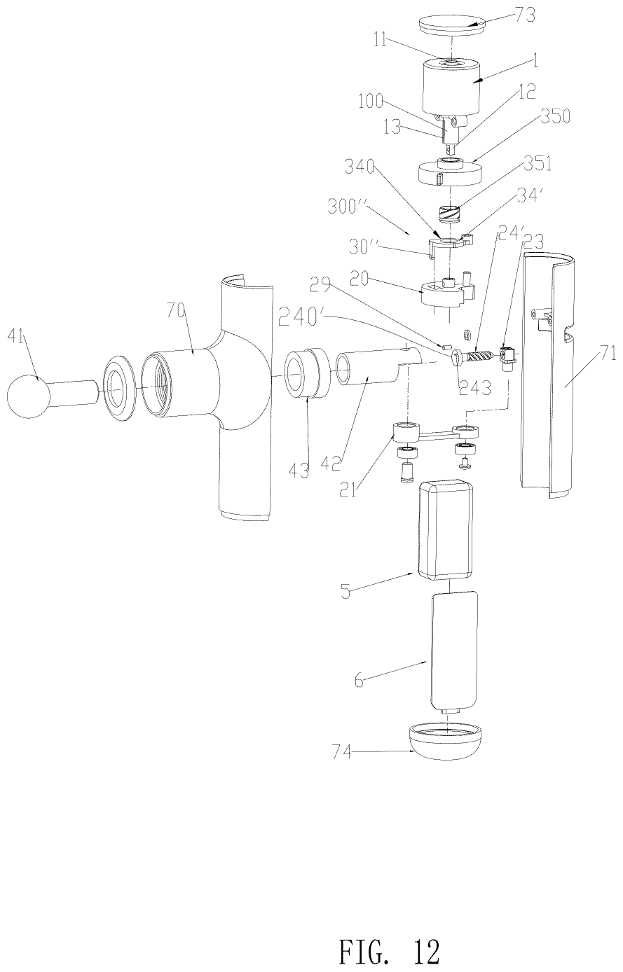

Referring to FIGS. 11-12, a third embodiment of the massage device of the present invention is shown. Compared to the first and second embodiments, the transmission assembly 300 of the adjustment assembly 3 is replaced with a tangential force assembly 300″, which comprises a tangential pull rod 30″ and a movable block 34′. The tangential pull rod 30″ is vertically arranged in parallel to the axial direction, replacing the transmission member (bevel gear) 30 in the first embodiment or the rack 30′ in the second embodiment. The movable block 34′ of the second and third embodiments differs from the movable block 34 of the first embodiment in that the internal threaded hole 341 is not provided, while similarly, the threaded sleeve 351 is sleeved in the central shaft holes 340 of the adjustment disk 350 and the movable block 34′, and the linear reciprocating motion of the threaded sleeve 351 drives the movable block 34′ to reciprocate synchronously. The tangential pull rod 30″ and the movable block 34′ may be an integral component, and the tangential pull rod 30″ is arranged perpendicular to the movable block 34′. Alternatively, the tangential pull rod 30″ may be fixedly mounted to the movable block 34′. The linear reciprocating motion of the threaded sleeve 351 drives the movable block 34′ to reciprocate synchronously, thereby driving the tangential pull rod 30″ to reciprocate synchronously. The bolt member 24′ of the bolt assembly 200 of this embodiment differs from the first and second embodiments in that the head of the bolt member 24′ utilizes a circular nut (head) 240′ instead of the bevel gear head 240; a protruding pin 243 is arranged on an end face of the circular nut 240′ at a position offset from its center (preferably on a circumferential edge or close to the circumferential edge of the circular nut). The end of the tangential pull rod 30″ is provided with a bore. The tangential pull rod 30″ passes through the through-hole 26 in the crank 20 to connect with the bolt member 24′; the protruding pin 243 on the end face of the circular nut of the bolt member 24′ is fitted into the bore at the end of the tangential pull rod 30″. The linear reciprocating motion of the threaded sleeve 351 drives the movable block 34′ to reciprocate synchronously, so the tangential pull rod 30″ performs linear reciprocating motion to apply tangential pulling force to the circular nut (head) 240″, driving the circular nut (head) 240″ (i.e., driving the screw element 24′) to rotate.

Other structures of the massage device in the second embodiment are the same as those of the embodiments, and the relevant descriptions in the embodiments are directly introduced into the second embodiment and will not be repeated here.

In other embodiments, the adjustment assembly 3 may be a gear assembly. In this case, the adjustment disk 350 may be a gear disk, and multi-stage gear connections may be provided as needed; and by toggling or driving the adjustment disk (gear disk) 350 and engaging with other gears or racks, the threaded sleeve 351 is driven to reciprocate linearly. The threaded sleeve 351 may also be configured as a gear or rack as needed.

The massage head assembly 4 of the above embodiment can be in various forms, not limited to the connecting sleeve 42 connecting the massage head 41, and the shape of the massage head is not limited to the shape shown in the accompanying drawings. That is: connect the massage head assembly 4 to the linkage rod 21, and drive the crank 20 to rotate by the driving device 1, thereby drive the massage head assembly 4 to perform a massage action through the linkage rod 21.

The bevel gear in the above embodiments may also be replaced by spur gears.

The arrows in the accompanying drawings indicate the movement direction of the corresponding parts.

Although embodiments of the present invention have been shown and described, it will be appreciated by those skilled in the art that various changes, modifications, substitutions and variations may be made to these embodiments without departing from the principles and spirit of the present invention, and that protection scope of the present invention is limited by the appended claims and their equivalents.

1. A massage device with an adjustable massage depth, comprising:
a massage head assembly;
a crank;
a driving device;
an adjustment assembly;
a movable connection assembly, driven to move by the adjustment assembly, comprising:
a bolt member, driven to rotate by the adjustment assembly, comprising:
an external threaded shaft, mounted to the crank; and
a head; and
a nut member, sleeved on and threadedly engaged with the external threaded shaft, movable along the external threaded shaft when the bolt member rotates;
a linkage rod, with a first end thereof connecting the nut member so as to connect the crank, and a second end thereof connected to the massage head assembly;
wherein the driving device is used to drive the crank to rotate about a rotation center axis, and drive the massage head assembly to perform massage actions through the linkage rod; the adjustment assembly is used to rotate the bolt member of the movable connection assembly to move the nut member, and a movement of the nut member changes a distance between a connection position of the linkage rod to the crank and the rotation center axis, thereby adjusting the massage depth of the massage head assembly.

2. (canceled)

3. The massage device according to claim 1, wherein the head of the bolt member is a toothed head, and the adjustment assembly comprises a toothed structure that meshes with the toothed head of the bolt member to drive the bolt member to rotate;
or, the head is a circular head, and the adjustment assembly comprises a tangential force mechanism that provides tangential force to the circular head to drive the bolt member to rotate.

4. The massage device according to claim 3, wherein the toothed structure of the adjustment assembly is a rack or a gear, and correspondingly, the toothed head of the bolt member is provided with straight teeth or helical teeth;
the tangential force mechanism of the adjustment assembly is a pull rod which is connected to the circular head to provide a tangential pulling force.

5. The massage device according to claim 3, wherein the bolt member is a bevel gear; the toothed structure of the adjustment assembly is a rack or a bevel gear; and the bevel gear either of the bolt member or the adjustment assembly comprises a bevel-gear head and an external threaded shaft.

6. The massage device according to claim 2, wherein the nut member has a pivot connected to the first end of the linkage rod at a central axis, which is parallel to the rotation center axis; a central axis of the bolt member is arranged along a crank rotation radius and is perpendicular to the rotation center axis.

7. The massage device according to claim 1, wherein the adjustment assembly comprises a threaded assembly or a gear assembly, and further comprises a transmission assembly; the transmission assembly is connected between the nut member of the movable connection assembly and the threaded assembly or the gear assembly, and the movement of the threaded assembly or the gear assembly drives the nut member of the movable connection assembly to move through the transmission assembly;
the transmission assembly comprises a movable block and a transmission member; the movable block is connected to the threaded assembly or the gear assembly, the movement of the threaded assembly or the gear assembly drives a movement of the nut member of the movable block; the movement of the movable block drives a movement of the transmission member, which in turn drives the movement of the nut member of the movable connection assembly;
the threaded assembly or the gear assembly is moved by a manual manner or an electric driving device.

8. The massage device according to claim 1, wherein the adjustment assembly comprises a threaded assembly and a transmission assembly;
the transmission assembly comprises a movable block and a transmission member; the movable block is connected to the threaded assembly, and a movement of the threaded assembly drives the nut member of the movable block to move;
the movable block cooperates with the transmission member, and the movable block drives the transmission member to move; or, the transmission member and the movable block are an integral component, and the movable block and the transmission member are movable together; the movement of the transmission member drives the nut member of the movable connection assembly to move;
the driving device comprises an output shaft, which is connected to the crank to drive the crank to rotate about the rotation center axis, and the output shaft is located on the rotation center axis.

9. The massage device according to claim 8, wherein the threaded assembly comprises an adjustment disk and a threaded sleeve threadedly that is engaged with the adjustment disk;
the adjustment disk has a central shaft hole, which is internally threaded; the threaded sleeve is externally threaded, a first end of the threaded sleeve is sleeved in the central shaft hole of the adjustment disk and is threadedly engaged, and a second end is connected to the movable block; when the adjustment disk rotates, the threaded sleeve performs a linear reciprocating motion in the central shaft hole of the adjustment disk; the linear reciprocating motion of the threaded sleeve drives a linear reciprocating motion of the movable block;
the adjustment disk is driven to rotate by a manual manner or an electric driving device.

10. The massage device according to claim 9, wherein the movable block has a shaft hole, and the crank has a central shaft hole;
the second end of the threaded sleeve is connected to the shaft hole of the movable block;
a shaft sleeve is coaxially arranged outside the output shaft to protect the output shaft, and the output shaft is rotatable within the shaft sleeve;
the output shaft and the shaft sleeve are inserted into the threaded sleeve in the central shaft hole of the adjustment disk, and further inserted into the shaft hole of the movable block, and the output shaft is connected to the central shaft hole of the crank to drive the crank to rotate together.

11. The massage device according to claim 10, wherein a limit guide structure is provided between the threaded sleeve and the shaft sleeve to enable the threaded sleeve to reciprocate linearly along the shaft sleeve;
a limit guide structure is provided between the movable block and the crank to guide and limit the movable block to perform the linear reciprocating motion relative to the crank while rotate together with the crank;
a matching structure of an annular flange and annular groove is provided between the second end of the threaded sleeve and the shaft hole of the movable block, and the second end of the threaded sleeve is connected to the movable block by means of the flange being received in the annular groove;
a connection between the movable block and the threaded sleeve is configured such that the movable block is rotatable relative to the threaded sleeve while is reciprocatable linearly together with the threaded sleeve.

12. The massage device according to claim 9, wherein the transmission member is a toothed structure; the head of the bolt member is a toothed head, which meshes with the toothed structure of the transmission member, thereby, the movement of the transmission member drives the bolt member to rotate; or, the transmission member is a tangential force mechanism that provides tangential force to the head of the bolt member to drive the bolt member to rotate through the movement of the transmission member.

13. The massage device according to claim 12, wherein the transmission member is a bevel gear or a spur gear, comprising an external threaded shaft and a bevel-gear head or a straight-tooth head; the movable block has an internal threaded hole, and the external threaded shaft of the transmission member is inserted into the internal threaded hole and threadedly engaged therewith; the linear reciprocating motion of the movable block drives the transmission member to rotate; the toothed head of the bolt member is a bevel-gear head or a straight-tooth head; the two bevel-gear heads or two straight-tooth heads of the transmission member and the bolt member engage with each other, and a rotation of the transmission member drives the bolt member to rotate; or
the transmission member is a rack, which is mounted to the movable block or is an integral part of the movable block, and reciprocates together with the movable block; the rack engages with the toothed head of the bolt member, and a linear reciprocating motion of the rack drives the bolt member to rotate; or
the transmission member is a pull rod, which is mounted to the movable block or is an integral part of the movable block, and reciprocates together with the movable block; an end of the pull rod is connected to the head of the bolt member, and a linear reciprocating motion of the pull rod provides tangential pulling force to the head of the bolt member, thereby driving the bolt member to rotate.

14. The massage device according to claim 1, wherein the massage device comprises a housing, a power supply assembly, and a control board assembly; the driving device, the crank, the linkage rod, the massage head assembly, the power supply assembly, and the control board assembly are arranged in the housing; the control board assembly comprises a main control board and buttons; the buttons, the power supply assembly, and the driving device are electrically connected to the main control board; the main control board is provided with a charging port for connecting an external power supply.
